(19) United States
(12) Patent Application Publication
(10) Pub. No.: US 2012/0017404 A1
(43) Pub. Date: Jan. 26, 2012

(54) Touch-and-close fastener part and method for producing a touch-and-close fastener part

(75) Inventor: Konstantinos Poulakis, Hildrizhausen (DE)

(73) Assignee: Gottlieb Binder GmbH & Co. KG

(21) Appl. No.: 13/137,091

(22) Filed: Jul. 20, 2011

(30) Foreign Application Priority Data
Jul. 20, 2010 (DE) 10 2010 027 616.2

(51) Int. Cl. A44B 18/00; B23P 11/00

(52) U.S. Cl. 24/451; 24/452; 29/428

(57) ABSTRACT

1. Touch-and-Close Fastener Part and Method for Producing a Touch-and-Close Fastener Part

2. A touch-and-close fastener part (32) comprising:
a functional layer which fixes a backing surface, formed from a thread system with at least two line elements (12a-12d, 14a-14c) which form meshes (16a-16b″, 20a-20a″) and which are connected to one another,
at least one further individual functional layer which has formed and/or formable connecting elements (30, 30″), which layer is formed from a further thread system which is incorporated at least in individual sections into the thread system,
is characterized in that the thread systems are connected to one another with the formation of passage sites (24a-24d) whose free cross-sectional area takes up more than 20% of the corresponding backing area.

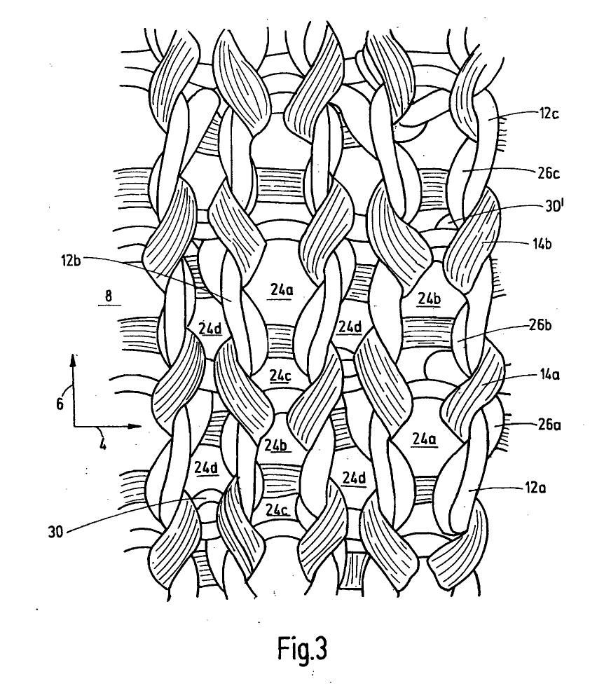

3. FIG. 3

The invention relates to a touch-and-close fastener part comprising a functional layer which fixes a backing surface that is formed from a thread system with at least two line elements which form meshes and which are connected to one another, and at least one individual further functional layer which has formed and/or formable connecting elements, which functional layer is formed from a thread system which is incorporated at least in individual sections into the thread system.

Touch-and-close fastener parts of this type are used in a wide variety of areas, especially in fastening systems, for example, on articles of clothing, luggage, pieces of furniture, linings in vehicle interiors, etc., and are accordingly known in very widely varying designs. Typically, the touch-and-close fastener part is a textile surface touch-and-close fastener with mushroom-shaped interlocking elements and is generally made of a plastic material. On a back which faces away from the connecting elements, the touch-and-close fastener part can have a coating, for example, an adhesive layer.

Another application of a touch-and-close fastener part is the connection or fastening of an abrasive wheel to an abrasive holder. EP 0 781 629 B1 discloses an abrasive wheel consisting of a layer having an abrasive, which is impermeable to particle flow, and which can be fastened directly or indirectly via an adapter to an abrasive holder in a work environment, with openings which penetrate at least the layer which has the abrasive, and a hook and loop fastener adaptation layer which is designed to be permeable to gas and particles. The openings are made as perforations through which gas and particles can flow and which are distributed almost uniformly over the entire surface of the abrasive wheel or a part of it, the individual openings which form the perforation being connected to one another and their distance to one another being chosen such that almost unimpeded continuous removal of the grinding dust is enabled.

An adapter used in this connection consists of a hook and loop fastener adaptation layer, a foam particle layer, and a velour layer, the hook and loop fastener adaptation layer, which faces toward the grinding wheel, being penetrated by the perforations. A typically round grinding wheel has a velour on its back for adhering to the grinding plate. The corresponding arrangement of the opening of the perforations relative to one another and relative to the extraction means of the grinding disk causes almost unimpeded transport of the grinding dust to the extraction means.

Proceeding from this prior art, the object of the invention is to provide a touch-and-close fastener part which has a simple structure, which in particular can be easily produced and which can be used to fasten a grinding wheel to an abrasive holder without impeding the grinding process.

This object is achieved according to the invention by a touch-and-close fastener part with the features of claim 1 in its entirety. Because the thread systems are connected to one another with the formation of passage sites whose free cross-sectional area takes up more than 20% of the corresponding backing area, on the contact or fastening surface the grinding dust which is suctioned off from the grinding wheel for the most part passes unhindered through the touch-and-close fastener part. The touch-and-close fastener part according to the invention in particular offers the advantage that, when a grinding wheel is fastened to the abrasive holder, no special alignment of the touch-and-close fastener part relative to the grinding wheel or the abrasive holder need be chosen since the touch-and-close fastener part is made permeable to dust over its entire surface, more precisely in the region of the further functional layer.

The use of the touch-and-close fastener part according to the invention is not limited to the field of grinding wheels, but extends to any field in which fluid passage on a fastening surface is desired and/or essential. For example, fastening of a screen which is used for waste water cleanup or exhaust air cleaning in an area through which fluid flows or a filter element which is used in a hydraulic system is conceivable. Use in the area of breathable textiles which are used, among other things, in the medical or healthcare field is also conceivable.

In one preferred embodiment of the touch-and-close fastener part according to the invention, at least one thread system which forms a functional layer comprises a series arrangement of at least two line elements which are adjacent to one another and which run in a longitudinal direction, the line elements each forming a sequence of essentially identical meshes which face in a transverse direction and are arranged without offset to one another in the longitudinal direction, and one or more meshes of at least one line element extending through or around the corresponding meshes of the respectively adjacent line element and thus connecting them to one another. This offers the advantage of a touch-and-close fastener part which is simple to produce and which is of stable shape, and especially a stable, loadable backing surface. The meshes of the individual line elements can be made meandering and can each have a rectangular contour. Alternatively, the meshes can be made loop-like and can have an elliptical or circular contour.

In another preferred embodiment of the touch-and-close fastener part according to the invention, the thread system which forms the further functional layer comprises at least one line element which runs in the longitudinal direction with a sequence of essentially identical meshes which face in the transverse direction and which are separable and/or separated at least partially for the formation of connecting elements. Especially preferably, the at least one line element of the further functional layer runs along a corresponding line element in the backing surface and is accordingly connected to (one) adjacent line element(s). In this way, the further thread system which forms the further functional layer, typically a connecting layer, can be easily incorporated into the thread system which forms the backing layer. A correspondingly configured production method can be easily implemented, especially with a weaving or knitting device which is suitable for formation of the thread system.

Advantageously, the meshes of adjacent line elements in the longitudinal direction have the same extension and/or sequence. In this way, an especially secure and stable bond between the line elements is formed. More preferably the thread system which forms the backing surface has a series arrangement of alternating first and second line elements, the first meshes of the first line elements in the transverse direction having a greater extension than the second meshes of the second line elements. In this configuration of the touch-and-close fastener part, comparatively fixed connecting sites are created at the crossing points between the meshes of adjacent line elements, as a result of which the mesh arrangement is for the most part fixed in position.

In one preferred configuration, the touch-and-close fastener part according to the invention has a pattern which repeats at regular intervals in the transverse and/or the longitudinal direction with essentially identically designed and/or arranged line elements of the thread systems. This offers the advantage of a structure which is uniform over the functional layers and backing surface and consequently provides the advantage of uniform properties of the touch-and-close fastener part, such as dimensional stability, elasticity, and fluid permeability.

Advantageously, the functional layer over the entire backing surface is connected to the further thread system, in other words, the touch-and-close fastener part is designed over the entire surface in the manner according to the invention. An elastic or flexible configuration of the touch-and-close fastener part allows it to be attached as a decorative textile fabric on 3D contours, which are sometimes complicated, for the purpose of covering them. The touch-and-close fastener part according to the invention is an especially soft, stretchable, open-pored surface structure. The passage openings cleared by the touch-and-close fastener part can be made in the manner of a parallelogram, especially diamond-shaped or rectangular, and/or polygonal, especially hexagonal. In this way, a stable functional layer bond can be ensured with sufficient dimensional stability and fluid permeability of the touch-and-close fastener part.

Advantageously, the touch-and-close fastener part according to the invention consists of a preferably thermoplastic material, especially polyamide, and preferably isotactic polypropylene. The plastic material is especially preferably recyclable. Isotactic polypropylene is especially well suited for forming interlocking elements with mushroom heads. The line elements of the thread systems are typically made as monofilaments, multifilaments, and/or yarns. They can be dyed according to a desired application.

The connecting elements of the touch-and-close fastener part according to the invention are typically made mushroom-like and have interlocking heads. It is furthermore advantageous to form the connecting elements on one side of the touch-and-close fastener part. Thus a back of the touch-and-close fastener part free of connecting elements is available as a connecting surface to a component such as an abrasive holder. More preferably, an adhesive surface is applied there. But it is also conceivable to provide one further functional layer with connecting elements on both sides, i.e., on the top and bottom of the touch-and-close fastener part.

The invention furthermore encompasses a method for producing a touch-and-close fastener part according to claim 14. Advantageous versions of the method are specified in claims 15 and 16. Other advantages and features will become apparent from the following description and the figures of the drawings. The features shown in the figures are purely schematic and not to scale.

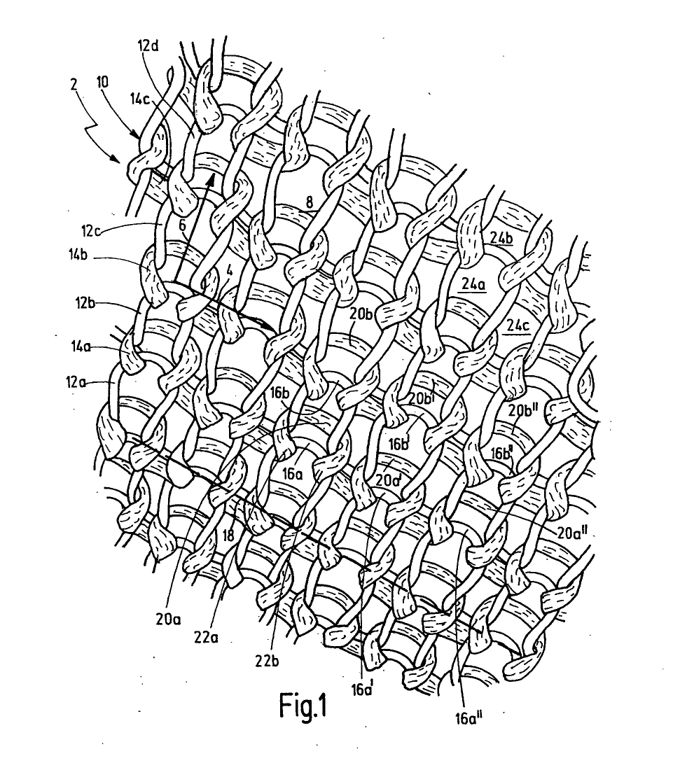

FIG. 1 shows a functional layer of a touch-and-close fastener part according to the invention, which layer fixes a backing surface;

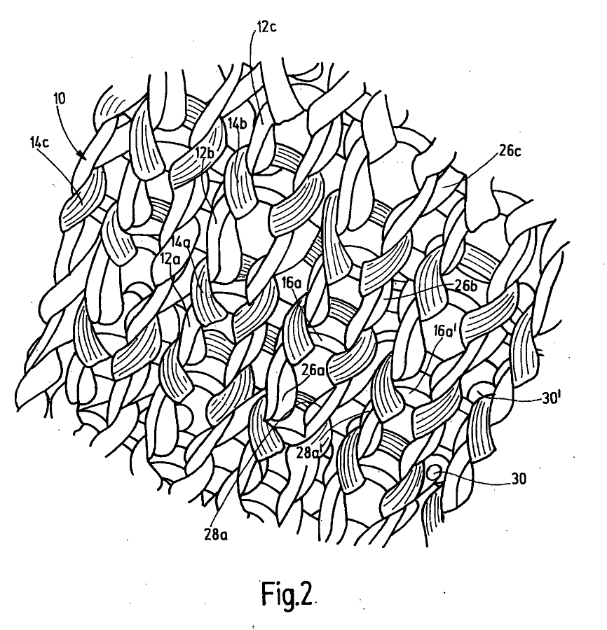

FIG. 2 shows the functional layer from FIG. 1 with a further functional layer incorporated into it;

FIG. 3 shows the bottom of the touch-and-close fastener part from FIG. 2 enlarged;

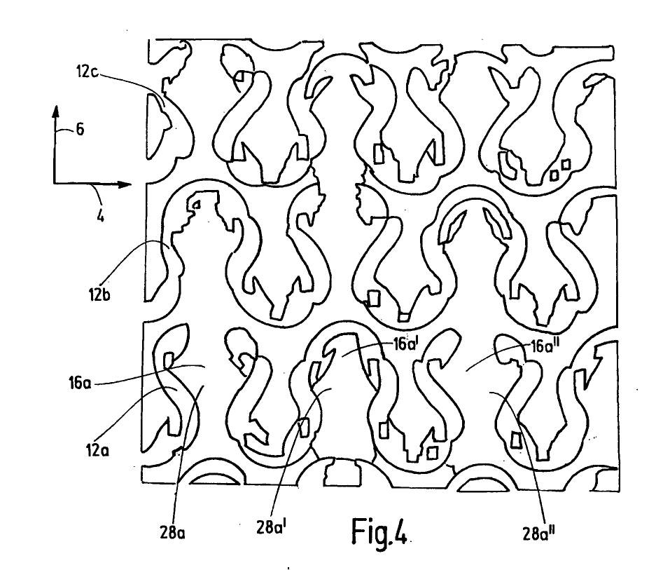

FIG. 4 shows a schematic which illustrates the arrangement of the two thread systems which form the functional layers;

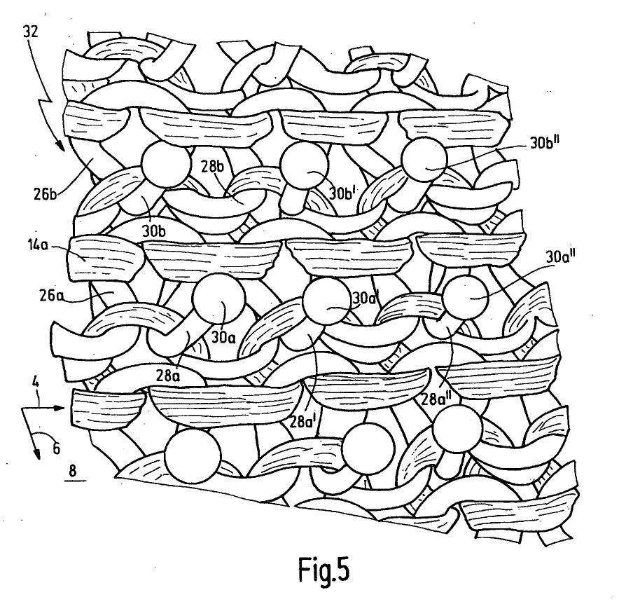

FIG. 5 shows the top of the touch-and-close fastener part from FIGS. 2 and 3;

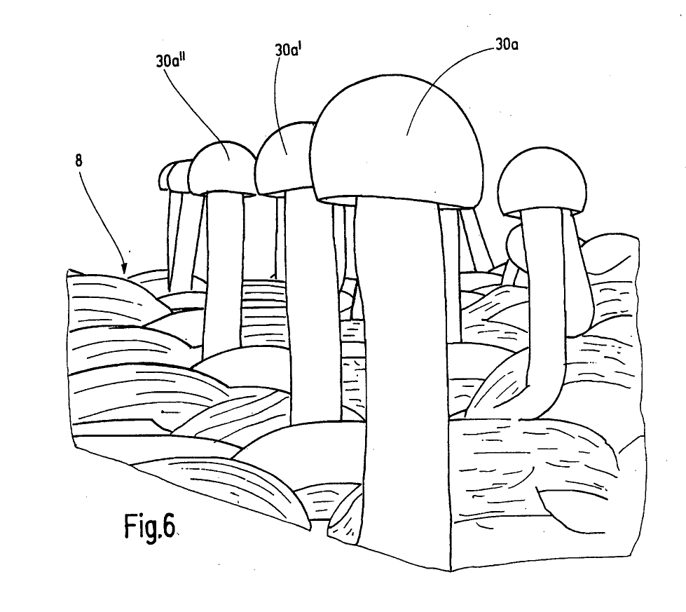

FIG. 6 shows an extract of the top of the touch-and-close fastener part from FIG. 5, which extract is enlarged for enhanced representation of connecting elements;

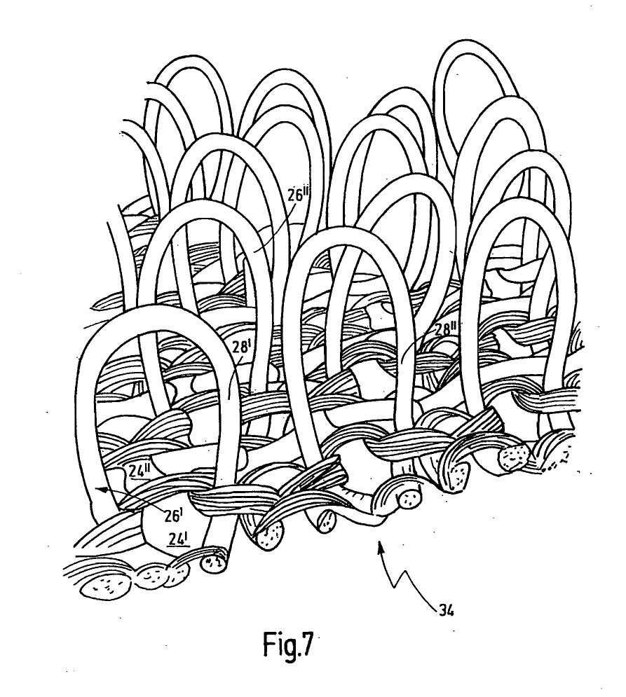

FIG. 7 shows a top of a semi-finished article of another touch-and-close fastener part according to the invention with two functional layers; and

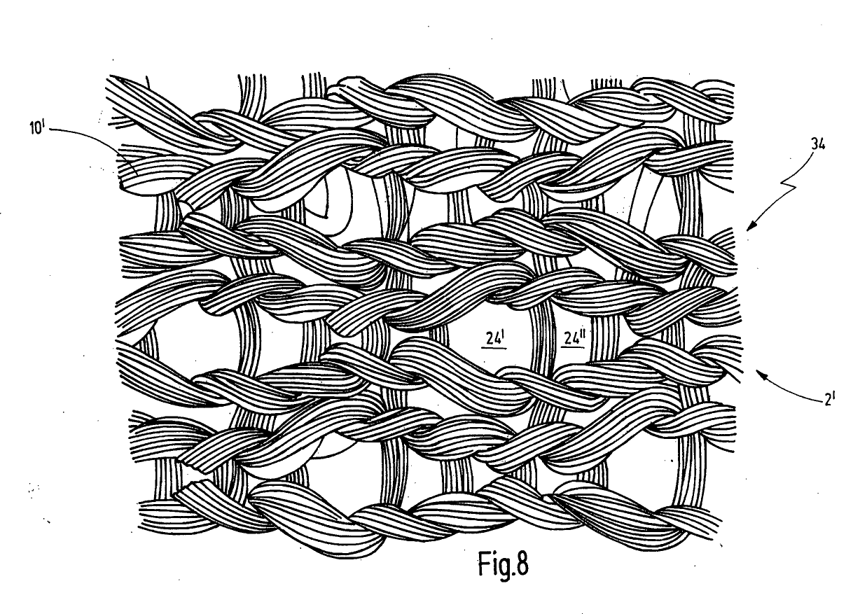

FIG. 8 shows a bottom of the semi-finished article from FIG. 7.

FIG. 1 shows a functional layer 2 which fixes a backing surface 8 which extends in a longitudinal direction 4 and a transverse direction 6. In the plane of the backing surface 8, there is a thread system 10 which comprises first line elements 12a, 12b, 12c, 12d and second line elements 14a, 14b, 14c. The first and second line elements 12a to 12d, 14a to 14c are essentially arranged running parallel to one another in the longitudinal direction 4 (sequence 12a, 14a, 12b, 14b, 12c, 14c, 12d). The first line elements 12a to 12d are arranged in the thread system 10 such that they each form one sequence of first meshes 16a, 16a′, 16a″ of the first line element 12a, first meshes 16b, 16b′, 16b″ of the first line element 12b, etc. The first meshes 16a, 16a′, 16a″ are made essentially identical, and each extend in the transverse direction 6. As is indicated by a line 18 for the first line element 12a, the first meshes 16a to 16a″ run from the line 18 in the transverse direction 6 and back again to the line 18, with a rectangular contour being established or a rectangular path being in part traversed by the respective first mesh 16a to 16a″. The first line elements 12a to 12d are arranged without offset in the longitudinal direction 4 so that in the transverse direction 6, the first mesh 16b of the adjacent first line element 12b adjoins the first mesh 16a of the first line element 12a.

The second line elements 14a to 14c each have a sequence of second meshes 20a, 20a′, 20a″ of the second line element 14a, second meshes 20b, 20b′, 20b″ of the second line element 14b, etc. The second meshes 20a to 20b″ are each made identical and, since the second line elements 14a to 14c are arranged without offset to one another in the longitudinal direction 4, in the transverse direction 6, they are arranged in direct succession to one another. The connection or interweaving of the first and second line elements 12a to 12d, 14a to 14c is detailed using the example of the second mesh 20a: The second mesh 20a extends through the first mesh 16a of the first line element 12a and is routed around the first mesh 16b of the adjacent line element 12b, in other words, the first mesh 16b is routed through the second mesh 20a of the second line element 14a. The first mesh 20a at two connecting sites 22a, 22b bonds the adjacent first line elements 12a, 12b to one another, which are stabilized in their respective locations. To form correspondingly strong connecting sites 22a, 22b, the extension of the second mesh 20a in the transverse direction 6 is shorter than the corresponding extension of the first meshes 16a and 16b.

The first line elements 12a to 12d are each formed from a monofilament, while the second line elements 14a to 14d are each formed from a multifilament. The thread thickness and the mesh width of the first and second line elements 12a to 12d, 14a to 14c are chosen such that free passage sites 24a, 24b, 24c are created between the first and second line elements 12a to 12d, 14a to 14c, as a result of which the thread system 10 or the functional layer 2 is permeable to fluid. The free passage or cross-sectional areas of the passage sites 24a to 24c constitute or occupy far more than 20% of the backing surface 8.

FIG. 2 shows how a further thread system of three line elements 26a, 26b, 26c is incorporated or woven into the thread system 10 of FIG. 1. The third line elements 26a to 26c each follow the path of a first line element 12a, 12b, 12c and are connected to one another via second line elements 14a, 14b. According to the first line elements 12a to 12c, the third line elements 26a to 26c have third meshes 28a, 28a′ which each follow the paths of first meshes 16a, 16a′ and are separated at the regular interval of two meshes 28a and 16a to form two connecting elements 30, 30′ at a time which extend to the top (not shown).

FIGS. 3 and 4 show the regular arrangement of the line elements 12a to 12d, 14a to 14d, 26a to 26c and the resulting formation of a pattern. The first line elements 12a, 12b, 12c and the second line elements 14a, 14b form first meshes 16a, 16a′, 16a″ or second meshes (not labeled) which are arranged regularly both in the longitudinal direction 4 and also in the transverse direction 6 in succession and toward one another. The third line elements 26a to 26c which follow the path of the first line elements 12a to 12c are separated both in the longitudinal direction 4 and also in the transverse direction 6 at every other of the third meshes (not labeled) to form connecting elements 30, 30′.

In the illustrated and described exemplary embodiment, the third line elements 26a to 26c viewed in the longitudinal and transverse directions 4, 6 are separated at every other third mesh into connecting elements so that at these sites larger passage sites 24a compared to passage sites 24b are established for third meshes which have not been severed. Further passage sites 24c and 24d are formed by the arrangement of line elements 12a to 12d, 14a to 14c, 26a to 26c and form a corresponding pattern. Thus there arises a sequence which repeats in the transverse direction 6 according to a sequence of two first line elements 12a, 12b and two second line elements 14a, 14b and a sequence which repeats in the longitudinal direction 4 according to two meshes 16a, 16a′ and 20a, 20a′ and 28a, 28a′. This pattern unit is repeated along the backing surface 8 in the longitudinal and transverse directions 4, 6 and is visible both on the bottom which is shown in FIGS. 3 and 4 and also on the top which is shown in FIG. 5. Consequently, the backing surface 8 has a homogeneous dimensional stability and permeability for fluids, as for a grinding dust exhaust.

FIG. 5 shows a top of a touch-and-close fastener part 32 which is depicted in the preceding figures. Connecting elements 30a, 30a′, 30a″ of the third line element 26a and connecting elements 30b, 30b′, 30b″ of the third line element 26b project out of the backing surface 8 which is clamped in the longitudinal and transverse directions 4, 6. The third line elements 26a, 26b are connected to one another according to the first line elements (not labeled) by second line elements 14a. The connecting elements 30a to 30b″ each have a mushroom-shaped thickening on the free end and form a hooking hook and loop fastener. The mating component for the touch-and-close fastener part 32 can be, for example, a velour or a fleece. FIG. 5 clearly shows the regularity of the connecting elements 30a to 30b″, where in the longitudinal direction 4 every other third mesh 28a, 28a″ and in the transverse direction 6 likewise every other, i.e., never directly adjacent third meshes 28a and 28b, are separated and are formed into connecting elements 30a, 30a′.

In the illustrated example, for the third line elements 26a to 26c one monofilament at a time, especially made from isotactic polypropylene, has been used, but it is also conceivable to choose a material which ensures a grinding function for forming the third line elements 26a to 26c and especially the connecting elements 30a to 30b″. The connecting elements 30a to 30b″, as shown in detail in FIG. 6, can themselves be made as abrasives, but can also have been applied to the backing surface 8 in addition to functional elements which have a grinding function. FIG. 6 clearly shows the mushroom-shaped thickenings on the free ends of the connecting elements 30a to 30a″ and the sequential arrangement of the connecting elements 30a to 30a″ which project essentially vertically out of the backing surface 8.

FIGS. 7 and 8 show a semi-finished article 34 by means of which a further touch-and-close fastener part can be made. The intermediate product or semi-finished article 34 is characterized by third line elements 26′, 26″ or third meshes 28′, 28″ which project as loops on a top which is shown in FIG. 7. It is apparent from the bottom of the semi-finished article 34 shown in FIG. 8 that the thread system 10′ which forms the functional layer 2′ is formed completely from multifilaments. The passage sites 24′, 24″ enable good fluid passage through the functional layer 2′ and the semi-finished article 34 or a touch-and-close fastener part formed from it.

The above-described, highly air-permeable touch-and-close fastener part 32 can also be used especially in the automotive sector and preferably in the region of the seat part upholstery of motor vehicles. In particular, the touch-and-close fastener part 32 is suited for covering the upholstery materials of the vehicle seat to the outside, but there is still the possibility of airflow through the meshes of the touch-and-close fastener part which are open in this respect; in addition to increasing seating comfort, this also makes it possible to effectively climatize the seat accordingly, i.e., to optimally implement hot or cooling airflow. In addition to the fact that the touch-and-close fastener part can, as a result of its closure elements, be easily detached from the other upholstery covering or upholstery materials, there is also a possibility of replacing it with a correspondingly designed new touch-and-close fastener part.

1. A touch-and-close fastener part (32) comprising:
a functional layer (2, 2′) which fixes a backing surface (8) that is formed from a thread system (10, 10′) with at least two line elements (12a-12d, 14a-14c) which form meshes (16a-16b″, 20a-20a″) and which are connected to one another,
at least one further individual functional layer which has formed and/or formable connecting elements (30a-30b″; 30, 30″), formed from a further thread system which is incorporated at least in individual sections into the thread system (10, 10′),
characterized in that the thread systems (10, 10′) are connected to one another with the formation of passage sites (24a-24d; 24′, 24″) whose free cross-sectional area takes up more than 20% of the corresponding backing area (8).

2. The touch-and-close fastener part according to claim 1, characterized in that one thread system (10, 10′) which forms a functional layer (2, 2′) comprises a series arrangement of at least two line elements (12a-12d, 14a-14c, 26a-26c, 26′, 26″) which are adjacent to one another and which run in a longitudinal direction (4), the line elements (12a-12d, 14a-14c, 26a-26c, 26′, 26″) each forming a sequence of essentially identical meshes (16a-16b″, 20a-20b″, 28a-28b, 28′, 28″) which face in a transverse direction (6) and are arranged without offset to one another in the longitudinal direction (4), and one or more meshes (16a-16b″, 20a-20b″, 28a-28b, 28′, 28″) of at least one line element (12a-12d, 14a-14c, 26a-26c, 26′, 26″) extending through or around the corresponding meshes (16a-16b″, 20a-20b″, 28a-28b, 28′, 28″) of the respectively adjacent line element (12a-12d, 14a-14c, 26a-26c, 26′, 26″).

3. The touch-and-close fastener part according to claim 1, characterized in that the thread system which forms the further functional layer comprises at least one line element (26a-26b, 26′, 26″) which runs in the longitudinal direction (4) with a sequence of essentially identical meshes (28a-28b, 28′, 28″), facing in the transverse direction (6), which are at least partially, especially regularly, separable and/or separated for the formation of connecting elements (30a-30b″, 30, 30′).

4. The touch-and-close fastener part according to claim 2, characterized in that the at least one line element (26a-26b, 26′, 26″) of the further functional layer following the path of a corresponding line element (12a-12d) is located in the backing surface (8) and is incorporated via meshes (16a-16b″, 20a-20b″).

5. The touch-and-close fastener part according to claim 1, characterized in that the meshes (16a-16b″, 20a-20b″) of adjacent line elements (12a-12d, 14a-14c) have essentially the same extension and/or sequence in the longitudinal direction (4) and/or in the transverse direction (6).

6. The touch-and-close fastener part according to claim 1, characterized in that the thread system (10, 10′) which forms the backing surface (8) has a series arrangement of alternating first and second line elements (12a-12d, 14a-14c), the first meshes (16a-16b″) of the first line elements (12a-12d) in the transverse direction (6) having a greater extension than the second meshes (20a-20b″) of the second line elements (14a-14c).

7. The touch-and-close fastener part according to claim 1, characterized by a pattern which repeats at regular intervals in the transverse direction (6) and/or longitudinal direction (4), composed of essentially identically made and/or arranged line elements (12a-12d, 14a-14c, 26a-26c) of the thread systems (10).

8. The touch-and-close fastener part according to claim 1, characterized in that the passage openings (24a-24d, 24′, 24″) are made in the shape of a parallelogram, especially diamond-shaped or rectangular, and/or polygonal, especially hexagonal.

9. The touch-and-close fastener part according to claim 1, characterized in that the touch-and-close fastener part (32) is produced from a preferably thermoplastic material, especially polyamide or preferably isotactic polypropylene.

10. The touch-and-close fastener part according to claim 1, characterized in that the line elements (12a-12d, 14a-14c, 26a-26c, 26′, 26″) are made as monofilaments, multifilaments, and/or yarns.

11. The touch-and-close fastener part according to claim 1, characterized in that the connecting elements (30a-30b″, 30, 30′) have at least in part interlocking heads and/or are made mushroom-like.

12. The touch-and-close fastener part according to claim 1, characterized in that the connecting elements (30a-30b″, 30, 30′) are or can be arranged on one side of the touch-and-close fastener part (32).

13. Use of a touch-and-close fastener part according to claim 1 for fastening a grinding wheel to an abrasive holder and/or for forming and executing and arranging an abrasive.

14. A method for producing a touch-and-close fastener part (32), comprising a functional layer (2, 2′) which fixes a backing surface (8), which layer is formed from a thread system (10, 10′) with at least two line elements (12a-12d, 14a-14c) which form meshes (16a-16b″, 20a-20b″) and which are connected to one another and at least one individual further functional layer which has formed and/or formable connecting elements (30a-30b″, 30, 30′), formed from one further thread system which is incorporated at least in individual sections into the thread system (10, 10′), characterized in that the thread systems (10, 10′) are connected to one another with the formation of passage sites (24a-24d, 24′, 24″) such that their free cross-sectional area takes up more than 20% of the corresponding backing area (8).

15. The method according to claim 14, characterized in that meshes (28a-28b, 28′, 28″) which are provided on at least one line element (26a-26c, 26′, 26″) of the further thread system are separated and connecting elements (30a-30b″, 30, 30′) are formed.

16. The method according to claim 15, characterized in that the meshes (28a-28b, 28′, 28″) are clipped and the free end of the separated meshes (28a-28b, 28′, 28″) are melted on to form mushroom head-like thickenings, especially by singeing.
